(19) United States
(12) Patent Application Publication
(10) Pub. No.: US 2023/0166717 A1
(43) Pub. Date: Jun. 1, 2023

(54) TRIGGER CONDITIONS FOR HYBRID VEHICLE OPERATING MODE CHANGES

(71) Applicant: JAGUAR LAND ROVER LIMITED, Whitley, Coventry, Warwickshire (GB)

(72) Inventors: Matthew HANCOCK, Rugby, Warwickshire (GB); Olivier ROQUES, Banbury, Oxfordshire (GB); William HARRISON, Coventry, Warwickshire (GB); Matthew SULLIVAN, Hinkley, Leicestershire (GB); Blake HEMINGWAY, Coventry, Warwickshire (GB)

(21) Appl. No.: 17/920,739

(22) PCT Filed: Apr. 21, 2021
(86) PCT No.: PCT/EP2021/060458

§ 371 Date: Oct. 21, 2022

(30) Foreign Application Priority Data
Apr. 21, 2020 (GB) 2005807.9

(51) Int. Cl. B60W 20/20; B60W 20/13; B60W 10/06; B60W 10/08; B60K 6/52

(52) U.S. Cl. CPC B60W 20/20; B60W 20/13; B60W 10/06; B60W 10/08; B60K 6/52; B60W 2510/244; B60W 2520/10; B60W 2510/18; B60W 2710/083; B60W 2510/1005; B60W 2710/065; B60K 6/442

(57) ABSTRACT

Aspects of the present invention relate to a method and to a control system for a vehicle, the method comprising: determining that a trigger condition is satisfied, wherein satisfaction of the trigger condition is dependent on a vehicle speed of the vehicle relative to at least one threshold speed, the at least one threshold speed having a value corresponding to is vehicle speed no greater than four metres per second; and based at least on the determination, controlling when a mode change between a first operating mode and a second operating mode is performed, wherein in the first operating mode the internal combustion engine is in a disconnected state not configured to provide tractive torque, and an electric machine is configured to provide tractive torque, and wherein in the second operating mode at least the internal combustion engine is in a connected state configured to provide tractive torque.

### TECHNICAL FIELD

The present disclosure relates to trigger conditions for hybrid vehicle operating mode changes. In particular, but not exclusively it relates to trigger conditions for delaying connection of an internal combustion engine to vehicle wheels of a hybrid vehicle.

### BACKGROUND

A hybrid electric vehicle comprises an internal combustion engine and at least one electric machine. A ‘Through the Road’ parallel hybrid vehicle comprises an engine and a first electric machine, each associated with a respective different axle of the vehicle. Thus the only link between the different axles of the vehicle is an indirect connection by means of the wheels and the road surface on which the vehicle is travelling or “through the road”. This type of hybrid vehicle can operate in a number of power generation and torque provision modes.

In an electric vehicle mode the engine is in a deactivated state and a torque path between the engine and its respective axle is disconnected thus no tractive torque is provided to the axle associated with the engine. The electric machine is active and operable to provide tractive torque to the axle associated with the electric motor.

In a series hybrid electric vehicle mode, the engine is in an activated state but the torque path between the engine and its respective axle is disconnected. Thus, no tractive torque is provided to the axle associated with the engine. Instead the engine is used to drive a further electric machine that generates electrical power for transmission to the electric machine having an associated axle. This electric machine is active and operable to provide tractive torque to its associated axle.

In a parallel hybrid vehicle operating mode the engine is activated and the torque path between the engine and its respective axle is connected. Tractive torque is provided by both the electric machine and the engine to their respective axles concurrently, thereby enabling all-wheel drive operation.

In an internal combustion engine mode, the engine is in an activated state and the torque path between the engine and its associated axle is connected thereby enabling the engine to provide tractive torque to its associated axle. The electric machine is not operable to provide tractive torque and therefore no tractive torque is provided to the axle associated with the electric machine.

### SUMMARY OF THE INVENTION

It is an aim of the present invention to address one or more disadvantages associated with the prior art.

Aspects and embodiments of the invention provide a control system, a system, a vehicle, a method, and computer software as claimed in the appended claims.

According to an aspect of the invention there is provided a control system for controlling connection of an internal combustion engine of a vehicle, the control system comprising one or more controllers, wherein the control system is configured to: determine that a trigger condition is satisfied, wherein satisfaction of the trigger condition is dependent on a vehicle speed relative to at least one threshold speed, the at least one threshold speed having a value corresponding to a vehicle speed no greater than four metres per second; and based at least on the determination, control when a mode change between a first operating mode and a second operating mode is performed, wherein in the first operating mode the internal combustion engine is in a disconnected state not configured to provide tractive torque, and an electric machine is configured to provide tractive torque, and wherein in the second operating mode at least the internal combustion engine is in a connected state configured to provide tractive torque.

An advantage is that mode-change-induced vehicle jerk at low speeds can be mitigated.

The at least one threshold speed may comprise a rising speed threshold, wherein when the vehicle speed is at or above the rising speed threshold, the mode change is performed from the first operating mode to the second operating mode.

The control system may be configured to: determine that the mode change is required; and if the vehicle is moving but at the vehicle speed is below the rising speed threshold, inhibit the mode change until the vehicle speed has risen above the rising speed threshold.

The inhibition may be overridden if a torque request is greater than a torque threshold, enabling connection of the internal combustion engine before the vehicle speed reaches the rising speed threshold.

Satisfaction of the trigger condition may be dependent on a vehicle braking requirement, and wherein the at least one threshold may comprise a stationary vehicle threshold, wherein the control system may be configured to: if the vehicle braking requirement is below a brake threshold and the vehicle speed is below the stationary vehicle threshold, inhibit the mode change until the vehicle speed has risen above the rising speed threshold or until the vehicle braking requirement has risen above the brake threshold.

The determination that the mode change is required may be dependent on one or more of: electrical energy availability; a manually-selected vehicle operating mode; or a request from a vehicle subsystem dependent on activation of the internal combustion engine.

The rising speed threshold may be greater than or equal to a speed setpoint associated with vehicle creep.

The speed setpoint may comprise a vehicle creep speed setpoint, and wherein in the first operating mode the electric machine is configured to provide tractive torque to satisfy the vehicle creep speed setpoint.

The at least one threshold may comprise a falling speed threshold, wherein when the vehicle speed has fallen below the falling speed threshold, the mode change is performed from the second operating mode to the first operating mode.

The at least one threshold may depend on a selected gear ratio.

The first operating mode may be a series hybrid vehicle operating mode in which the internal combustion engine is configured to provide torque to a second electric machine to generate electrical energy.

In the first operating mode engine idle speed may be increased.

According to an aspect of the invention there is provided a system comprising the control system, the electric machine and the internal combustion engine.

According to an aspect of the invention there is provided a vehicle comprising the system.

In some examples, the vehicle is configured to mechanically provide torque from the internal combustion engine to a first axle of the vehicle and from the electric machine to a second axle of the vehicle, but is not capable of mechanically providing torque from the internal combustion engine to the second axle and is not capable of mechanically providing torque from the electric machine to the first axle.

According to an aspect of the invention there is provided a method of controlling connection of an internal combustion engine of a vehicle, the method comprising: determining that a trigger condition is satisfied, wherein satisfaction of the trigger condition is dependent on a vehicle speed of the vehicle relative to at least one threshold speed, the at least one threshold speed having a value corresponding to a vehicle speed no greater than four metres per second; and based at least on the determination, controlling when a mode change between a first operating mode and a second operating mode is performed, wherein in the first operating mode the internal combustion engine is in a disconnected state not configured to provide tractive torque, and an electric machine is configured to provide tractive torque, and wherein in the second operating mode at least the internal combustion engine is in a connected state configured to provide tractive torque.

According to an aspect of the invention there is provided computer software that, when executed, is arranged to perform the method. According to a further aspect of the invention there is provided a non-transitory computer readable medium comprising computer readable instructions that, when executed by a processor, cause performance of any one or more of the methods described herein.

According to an aspect of the invention there is provided a control system for a vehicle, the control system comprising one or more controllers, wherein, whilst the vehicle is operating in an electric vehicle mode, the control system is configured to: receive an engine connection request indicative of a request to connect the engine to the driveline of the vehicle; and output a signal to cause the engine to connect to the driveline of the vehicle, wherein the outputting of the signal is delayed until a trigger condition is satisfied. In some, but not necessarily all examples, the trigger condition may comprise a speed threshold, and/or the trigger condition may comprise a vehicle braking requirement.

According to an aspect of the invention there is provided a control system for a vehicle, the control system comprising one or more controllers, wherein the control system is configured to: determine that a mode change from a first operating mode to a second operating mode is required; and if the vehicle is moving but at a speed corresponding to a vehicle speed below a threshold speed, inhibit the mode change until a vehicle speed of the vehicle has risen above a threshold vehicle speed; and wherein in the first operating mode the internal combustion engine is in a disconnected state not configured to provide tractive torque, and an electric machine is configured to provide tractive torque, and wherein in the second operating mode at least the internal combustion engine is in a connected state configured to provide tractive torque.

According to an aspect of the invention there is provided a control system for a vehicle, the control system comprising one or more controllers, wherein the control system is configured to: determine that a vehicle speed of the vehicle has fallen below a threshold speed, the threshold having a value corresponding to a vehicle speed no greater than four metres per second; and based at least on the determination, perform a mode change from a second operating mode to a first operating mode, wherein in the first operating mode the internal combustion engine is in a disconnected state not configured to provide tractive torque, and an electric machine is configured to provide tractive torque, and wherein in the second operating mode at least the internal combustion engine is in a connected state configured to provide tractive torque.

The one or more controllers may collectively comprise: at least one electronic processor having an electrical input for receiving information; and at least one electronic memory device electrically coupled to the at least one electronic processor and having instructions stored therein; and wherein the at least one electronic processor is configured to access the at least one memory device and execute the instructions thereon so as to cause the control system to cause performance of the method.

Within the scope of this application it is expressly intended that the venous aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of a system;

FIGS. 3A, 3B illustrate an example of a control system and of a non-transitory computer-readable storage medium; and

FIG. 4 illustrates an example of a method.

### DETAILED DESCRIPTION

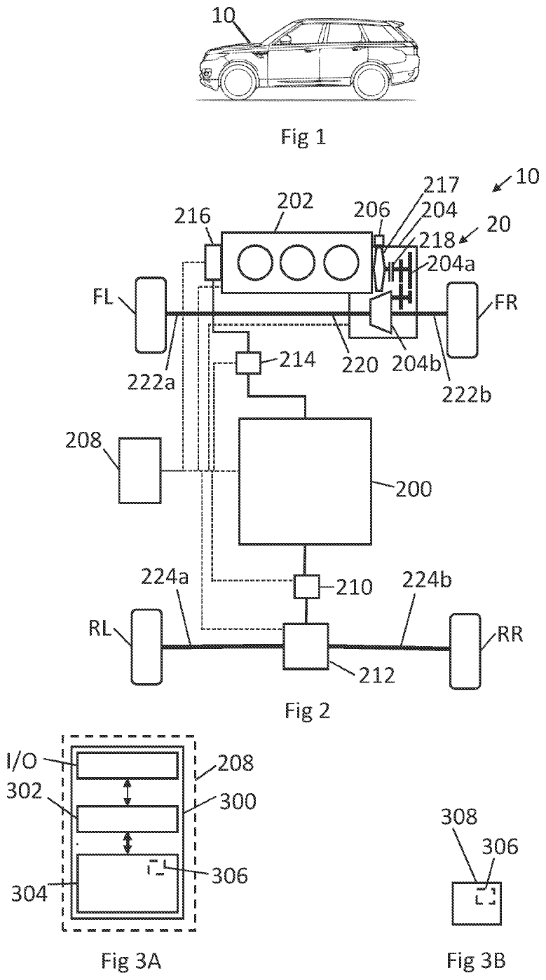

FIG. 1 illustrates an example of a vehicle 10 in which embodiments of the invention can be implemented. In some, but not necessarily all examples, the vehicle 10 is a passenger vehicle, also referred to as a passenger car or as an automobile. In other examples, embodiments of the invention can be implemented for other applications, such as industrial vehicles.

The vehicle 10 is a hybrid electric vehicle (HEV). The HEV may comprise an electric-only mode of propulsion. Further, the vehicle 10 may be configured to operate as a parallel HEV. Parallel HEVs comprise a torque path between the engine and at least one vehicle wheel, as well as a torque path between an electric machine and at least one vehicle wheel. The torque path(s) may be disconnectable by a torque path connector such as a clutch or transmission. Typically, parallel HEVs differ from series HEVs, because in series HEVs the purpose of the engine is to generate electrical energy and there is no torque path between the engine and vehicle wheels. However, some types of parallel HEVs may be configurable to operate as a series HEV, such as ‘through-the-road’ hybrids. In this case we may usefully describe such a hybrid vehicle as operating in a parallel HEV mode or in a series HEV mode, depending on whether torque is being delivered from the engine directly to the vehicle wheels.

FIG. 2 illustrates an example system 20 for an HEV 10. The system 20 defines, at least in part, a powertrain of the HEV.

The system 20 comprises a control system 208. The control system 208 comprises one or more controllers. The control system 208 may comprise one or more of: a hybrid powertrain control module; an engine control unit; a transmission control unit; a traction battery management system; and/or the like.

The system 20 comprises one or more torque sources. A torque source refers to a prime mover, such as an engine, an electric machine, or the like. An electric machine is also referred to herein as an electric machine. The illustrated system 20 comprises an engine 202. The engine 202 is an internal combustion engine (ICE). The illustrated engine 202 comprises three combustion chambers, however a different number of combustion chambers may be provided in other examples.

The engine 202 is operably coupled to the control system 208 to enable the control system 208 to control output torque of the engine 202. The output torque of the engine 202 may be controlled by controlling one or more of: air-fuel ratio; spark timing; poppet valve lift; poppet valve timing; throttle opening position; fuel pressure; turbocharger boost pressure; and/or the like, depending on the type of engine 202.

The system 20 comprises a transmission 204 for receiving output torque from the engine 202. The transmission 204 may comprise an automatic vehicle transmission, a manual vehicle transmission, or a semi-automatic vehicle transmission. The transmission 204 may comprise one or more torque path connectors 218, a torque converter 217, and a gear train 204a. The gear train 204a is configured to provide a selected gear reduction in accordance with a selected gear of the vehicle 10. The gear train 204a may comprise five or more different selectable gear reductions. The gear train 204a may comprise at least one reverse gear and a neutral gear.

The system 20 may comprise a differential 204b which is a second gear train for receiving output torque from the gear train 204a. The differential 204b may be integrated into the transmission 204 as a transaxle, or provided separately.

The engine 202 is mechanically connected (coupled) or connectable (couplable) to provide positive torque to a first set of vehicle wheels (FL, FR) via a torque path 220. The torque path 220 extends from an output of the engine 202 to the transmission 204, then and then to first set of vehicle wheels (FL, FR) via a first axle or axles 222a, 222b. In a vehicle overrun and/or friction braking situation, negative torque may flow from the first set of vehicle wheels (FL, FR) to the engine 202.

The illustrated first set of vehicle wheels (FL, FR) comprises front wheels, and the axles 222a, 222b are front transverse axles. Therefore, the system 20 is configured for front wheel drive by the engine 202. In another example, the first set of vehicle wheels comprises rear wheels (RL, RR). The illustrated first set of vehicle wheels (FL, FR) is a pair of vehicle wheels, however a different number of vehicle wheels and axles could be provided in other examples.

In the illustrated system 20, no longitudinal (centre) driveshaft is provided, to make room for hybrid vehicle components. Therefore, the engine 202 is not connectable to a second set of rear wheels (rear wheels RL, RR in the illustration). The engine 202 may be transverse mounted to save space. In an alternative example, the engine 202 may be configured to drive the front and rear wheels.

A torque path connector 218 may be provided inside and/or outside a bell housing of the transmission 204. The torque path connector 218 is configured to connect and configured to disconnect the torque path 220 between the engine 202 and the first set of vehicle wheels (FL, FR). The torque path connector 218 may be a part of the torque converter 217 or gear train 204a, or may be a separate friction clutch. The system 20 may be configured to automatically actuate the torque path connector 218 without user intervention.

The system 20 comprises a first electric machine 216. The first electric machine 216 may be an alternating current induction motor or a permanent magnet motor, or another type of motor. The first electric machine 216 is located so that when the torque path 220 is disconnected from the first set of vehicle wheels (FL, FR), the first electric machine 216 is also disconnected. Alternatively, the first electric machine 216 may be located so that it remains connected to the first set of vehicle wheels (FL, FR).

The first electric machine 216 may be mechanically connected (coupled) or connectable (couplable) to the engine 202 via a belt or chain. For example, the first electric machine 216 may be a belt integrated starter generator (BISG). The first electric machine 216 and the engine 202 together form a torque source for the first set of vehicle wheels (FL, FR). In the illustration, the first electric machine 216 is located at an accessory drive end of the engine 202, opposite a vehicle transmission end of the engine 202. In an alternative example, the first electric machine 216 is a crankshaft integrated motor generator (CIMG), located at a vehicle transmission end of the engine 202. A CIMG may be capable of sustained electric-only driving unlike typical BISGs.

The first electric machine 216 is configured to apply positive torque and configured to apply negative torque to a crankshaft of the engine 202, for example to provide functions such as: boosting output torque of the engine 202; deactivating (shutting off) the engine 202 while at a stop or coasting; activating (starting) the engine 202; generating power for ancillary loads; and/or regenerative braking in a regeneration mode. In a parallel HEV mode, the engine 202 and first electric machine 216 may both be operable to supply positive torque simultaneously to boost output torque. The first electric machine 216 may be incapable of sustained electric-only driving. In an alternative example, the first electric machine 216 is not controllable to provide positive torque other than to start the engine 202. In further examples, a pinion starter 206 is provided for starting the engine 202.

FIG. 2 illustrates a second electric machine 212, also referred to as an electric traction motor, configured to enable at least an electric vehicle mode comprising electric-only driving. Another term for the second electric machine 212 is an electric drive unit. In some, but not necessarily all examples, a nominal maximum torque of the second electric machine 212 is greater than a nominal maximum torque of the first electric machine 216.

Even if the torque path 220 between the engine 202 and the first set of vehicle wheels (FL, FR) is disconnected, the vehicle 10 can be driven in electric vehicle mode because the second electric machine 212 is mechanically connected to at least one vehicle wheel.

The illustrated second electric machine 212 is configured to provide torque to the illustrated second set of vehicle wheels (RL, RR). The second set of vehicle wheels (RL, RR) comprises vehicle wheels not from the first set of vehicle wheels (FL, FR). The illustrated second set of vehicle wheels (RL, RR) comprises rear wheels, and the second electric machine 212 is operable to provide torque to the rear wheels RL, RR via a second, rear transverse axle or axles 224a, 224b. Therefore, the illustrated vehicle 10 is rear wheel driven in electric vehicle mode. In an alternative example, the second set of vehicle wheels comprises at least one vehicle wheel of the first set of vehicle wheels. In a further alternative implementation, the second electric machine 212 is replaced with two electric machines, one for each rear vehicle wheel RL, RR.

The control system 208 may be configured to disconnect the torque path 220 between the engine 202 and the first set of vehicle wheels (FL, FR) in electric vehicle mode, to reduce parasitic pumping energy losses. For example, the clutch 218 may be opened. In the example of FIG. 2, this means that the first electric machine 216 with also be disconnected from the first set of vehicle wheels (FL, FR).

Another benefit of the second electric machine 212 is that the second electric machine 212 may also be configured to be operable in a parallel HEV mode, to enable multi-axle drive (e.g. at-wheel drive) operation despite the absence of a centre driveshaft.

In order to store electrical energy for the electric machines, the system 20 comprises an electrical energy storage means such as a traction battery 200. The traction battery 200 provides a nominal voltage required by electrical power users such as the electric machines.

The traction battery 200 may be a high voltage battery. High voltage traction batteries provide nominal voltages in the hundreds of volts. The traction battery 200 may have a voltage and capacity to support electric only driving for sustained distances. The traction battery 200 may have a capacity of several kilowatt-hours, to maximise range. The capacity may be in the tens of kilowatt-hours, or even over a hundred kilowatt-hours.

Although the traction battery 200 is illustrated as one entity, the function of the traction battery 200 could be implemented using a plurality of small traction batteries in different locations on the vehicle 10.

The first electric machine 216 and second electric machine 212 may be configured to receive electrical energy from the same traction battery 200 as shown.

Finally, the illustrated system 20 comprises inverters. Two inverters 210, 214 are shown, one for each electric machine. In other examples, one inverter or more than two inverters could be provided.

In an alternative implementation, the vehicle 10 may be other than shown in FIG. 2. For example, the first electric machine 216 may be connected through a clutch or gear to the engine 202, or may be located at the opposite end of the engine, possibly within the transmission 204 or on a driveshaft.

FIG. 3A illustrates how the control system 208 may be implemented. The control system 208 of FIG. 3A illustrates a controller 300. In other examples, the control system 208 may comprise a plurality of controllers on-board and/or off-board the vehicle 10.

The controller 300 of FIG. 3A includes at least one processor 302; and at least one memory device 304 electrically coupled to the electronic processor 302 and having instructions 306 (e.g. a computer program) stored therein, the at least one memory device 304 and the instructions 306 configured to, with the at least one processor 302, cause any one or more of the methods described herein to be performed. The processor 302 may have an electrical input/output I/O or electrical input for receiving information and interacting with external components.

FIG. 3B illustrates a non-transitory computer-readable storage medium 308 comprising the instructions 306 (computer software).

The control system 208 may be configured to provide controller outputs to control output torque to manipulate a variable (e.g. torque/speed) towards a setpoint. An example setpoint is a torque target or a speed target.

Output torque may be manipulated to satisfy at least one received torque request. A torque request may be a load-based torque request for the vehicle 10. This type of torque request may be referred to as a vehicle torque request or a total torque request for the whole vehicle, and is not specific to any particular torque source. The total torque request may be for a torque at the vehicle wheels. A load may be based on a driver torque demand (e.g. torque setpoint based on accelerator pedal depression APD), or autonomous driving torque demand, and/or dependent on a speed setpoint such as a cruise control speed setpoint.

Arbitration functions may be applied to change/increase the total torque request to satisfy a plurality of torque requests including load and requests from other vehicle subsystems. A shaping function may smooth the arbitrated total torque request.

The control system 208 may derive, from the shaped arbitrated total torque request, an engine torque request for controlling output torque of the engine, and/or an electric machine torque request(s) for controlling output torque of an electric machine or each electric machine, depending on a vehicle operating mode of the vehicle 10. A required torque split distribution function may control the derivation of the engine torque request and the electric machine torque request, wherein the electric machine is the second electric machine 212.

The required torque split may be a ratio. The torque split in this example is a front: rear torque split, between torque at the front and rear axles. The required torque split helps to maintain all-wheel drive balance of the vehicle 10 (front-biased, rear-biased, or 50:50). In some examples, the required torque split may vary dynamically. The required torque split may depend on variables such as: a driving dynamics mode; a terrain mode and/or a terrain type; vehicle speed; vehicle steering; lateral acceleration; and/or longitudinal acceleration; and/or other factors.

Shaping functions may be applied to smooth the engine and electric machine torque requests around a zero-crossing point (lash crossing), resulting in shaped engine and electric machine torque requests.

A system 20 such as the powertrain of FIG. 2 can be operated in a plurality of vehicle operating modes. Another term for the vehicle operating modes is ‘hybrid vehicle operating modes’, because they change between modes of the hybrid vehicle powertrain. In one or room vehicle operating modes, the engine 202 is deactivated and the torque path 220 between the engine 202 and the first set of vehicle wheels (FL, FR) is disconnected. In another one or more modes, the engine 202 is re-activated and the torque path 220 may be re-connected.

In electric vehicle mode, the engine 202 is in a deactivated state and the torque path 220 between the first set of vehicle wheels (FL, FR) and the engine 202 is disconnected. In an example, the effect of the combined deactivation and disconnection is that engine speed falls towards zero. Deactivation relates to the engine 202 producing no positive output torque or insufficient positive output torque for driving. Fuel injection may cease, to reduce fuel consumption.

In series HEV mode, the engine 202 is in an activated state but the torque path 220 is disconnected. The engine 202 and the first electric machine 216 generate electrical power, and the second electric machine 212 provides torque to the second set of vehicle wheels (RL, RR). One or both of the electric machines 212, 216 provides torque to vehicle wheels. If the second electric machine 212 is used, all-wheel drive is available.

In parallel HEV mode, the engine 202 is in an activated state and the torque path 220 is connected. In the activated state, fuel is combusted in the engine's combustion chambers, causing the engine 202 to provide positive output torque to the torque path 220. The engine 202 and the first electric machine 216 may optionally generate electrical power.

In an internal combustion engine mode, the engine 202 is in an activated state and the torque path 220 is connected. However, the first and second electric machines 212, 216 are not operable as motors to provide torque to the vehicle wheels. The engine 202 and the first electric machine 216 may optionally generate electrical power. The second electric machine 212 may optionally generate electrical power.

The vehicle operating mode may be selectable manually, semi-automatically, or automatically. A mode transition condition for changing to a vehicle operating mode that allows more charging than a current mode (e.g. exit electric vehicle mode) may require at least one of: a manual user selection; a traction battery state of charge falling below a threshold; a temperature being below a threshold (e.g. freezing weather); a change of driving dynamics mode; a change of terrain mode; an increase in power consumption due to a high load ancillary device being required to operate, such as an air conditioner unit or a heated windscreen and/or the like.

A mode transition condition for changing to a vehicle operating mode that allows more net torque than a current mode and/or all-wheel drive (e.g. parallel HEV mode) may require at least one of: a manual user selection; a torque request rising above a threshold (e.g. kickdown function); a change of driving dynamics mode; a change of terrain mode; and/or the like.

A mode transition condition for changing to a vehicle operating mode that allows more electric driving than a current mode (e.g. one of the HEV modes or electric vehicle mode) may require at least one of: a manual user selection; a traction battery state of charge rising above a threshold; torque request falling below a threshold; a temperature being above a threshold; a change of driving dynamics mode; a change of terrain mode; and/or the like.

A driving dynamics mode refers to a mode that configures one or more of: a suspension setting; a throttle response setting; a gear shift point setting; a vehicle braking or traction control setting; a torque distribution setting; a torque shaping setting; a steering weighting setting; and/or the like.

A terrain mode generally refers to vehicle modes optimized for driving over particular driving surfaces. An example of a terrain mode is an off-road terrain mode, arranged to optimize the vehicle for driving over off-road terrain such as may be required when traversing areas of grass, gravel, sand, mud or even crawling over rocks. Another example of a terrain mode is a surface vehicle optimization mode, arranged to optimize the vehicle for driving over low friction surfaces such as snow or ice covered surfaces, either on or off road. A vehicle may comprise a base on-road mode and/or a base surface vehicle optimization mode for regular surfaces, and may comprise a plurality of terrain modes for various surfaces and/or terrain.

A terrain mode and/or detection of a particular terrain type may configure one or more surface traction-related settings such as a differential locking setting and/or a traction control setting. Additionally, or alternatively, other settings could be adjusted such as: a suspension setting; a ride height setting; a suspension damper setting; a throttle response setting; a gear shift point setting; a selected gear; a vehicle braking or traction control setting; a torque distribution setting; a torque shaping setting; or a steering weighting setting. There may be overlap between driving dynamics modes and terrain modes. The settings may be predetermined or configurable.

A manual user selection may comprise use of a human-machine interface input device. The input device may comprise an engine start button. The input device may comprise a driving dynamics mode selector. The input device may comprise a terrain mode selector. In some examples, a terrain mode and/or driving dynamics mode may be changeable automatically.

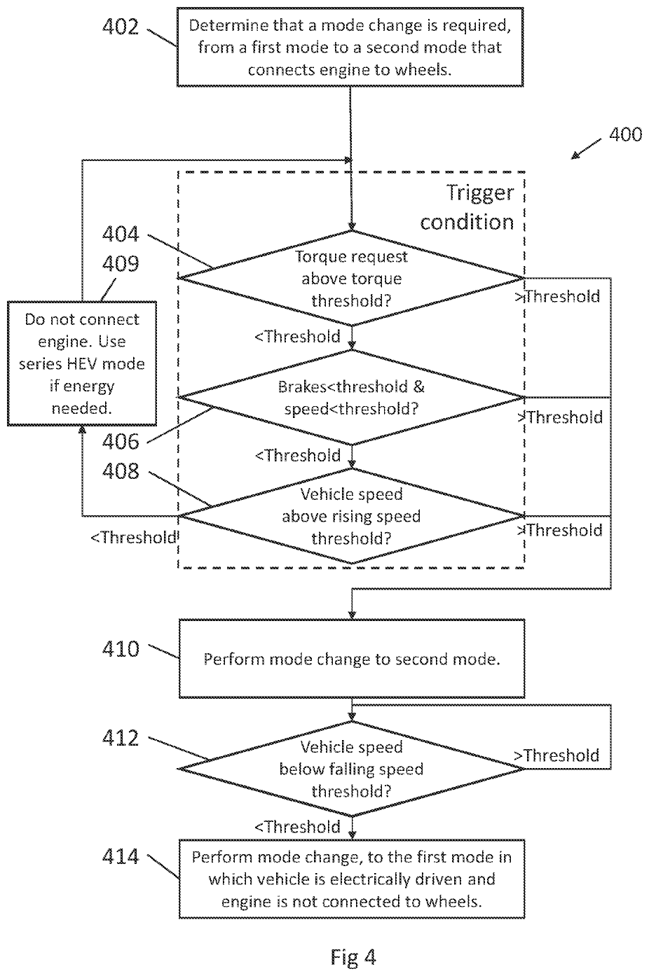

In accordance with an aspect of the invention, and as shown in part of FIG. 4, there is provided a computer-implemented method 400 for a vehicle 10, the method 400 comprising at least:
determining that a trigger condition is satisfied, wherein satisfaction of the trigger condition is dependent on a vehicle speed of the vehicle 10 relative to at least one threshold speed (block 408), the at least one threshold speed having a value corresponding to a vehicle speed no greater than four metres per second; and
based at least on the determination, controlling when a mode change between a first operating mode and a second operating mode is performed (block 410),
wherein in the first operating mode the internal combustion engine 202 is in a disconnected state not configured to provide tractive torque, and an electric machine is configured to provide tractive torque, and
wherein in the second operating mode at least the internal combustion engine 202 is in a connected state configured to provide tractive torque.

The method 400 may be performed by the control system 208. The first operating mode and the second operating mode may be vehicle operating modes as described earlier. Alternatively, the first operating mode and the second operating mode may simply be engine connection modes that control whether the engine 202 is connected to the vehicle wheels, rather than the above-described vehicle operating modes.

The illustrated method 400 comprises an example of a first optional subroutine associated with rising vehicle speed, the first subroutine comprising blocks 402 to 410. The illustrated method 400 further comprises a second optional subroutine associated with falling vehicle speed, the second subroutine comprising blocks 412 and 414. Alternatively, either subroutine may be patentable independently. Further, block 406 may be patentable independently as a trigger for mode-switching.

Prior to block 402 of the method 400, the vehicle 10 may be in a first vehicle operating mode.

In some examples, the first vehicle operating mode may be the electric vehicle mode in which the engine 202 is deactivated and in the disconnected state not configured to provide tractive torque to vehicle wheels. The torque path 220 may be disconnected.

In some examples, the first vehicle operating mode may be the series HEV mode in which the engine 202 is activated and generates torque for conversion to electrical power by an electric machine such as the first electric machine 216. The engine 202 is not connected to the vehicle wheels, such as the first set of vehicle wheels FL, FR.

Prior to block 402 of the method 400, the vehicle 10 may be static. Alternatively, the vehicle 10 may be rolling forward or backwards at a low speed. In some, but not necessarily all examples the vehicle 10 may be configured for electric vehicle creep while in the first vehicle operating mode.

The electric vehicle creep is a function provided by an electric machine such as the second electric machine 212. The electric vehicle creep function is controlled by a mathematical model of engine creep torque that would be provided by the engine 202 when the torque path 220 between the engine 202 and the first set of vehicle wheels FL, FR is connected. The electric vehicle creep function may control torque of the second electric machine 212 based on a vehicle creep speed setpoint. The mathematical model may be configured to limit the torque of the electric machine, based on the modelled engine creep torque, to enable an external environment to slow the vehicle 10. This replicates slipping behaviour of the torque converter 217.

Block 402 comprises determining that a mode change is required, from the first vehicle operating mode to a second vehicle operating mode. In the second vehicle operating mode, the engine 202 is in a connected state configured to provide tractive torque. That is, the torque path 220 may be connected.

The determination that a mode change is required may be based on receiving a mode change request. A mode change request has the effect of an engine connection request requiring connection of the engine 202 to the vehicle wheels.

The determination that the mode change is required may be based on satisfaction of a mode transition condition.

The mode transition condition may be dependent on electrical energy availability. For example, satisfaction of a mode transition condition dependent on electrical energy availability may require: electrical power limit of the traction battery 200 falling below a threshold; a state of charge of the traction battery 200 falling below a threshold; a temperature falling below a threshold (e.g. freezing weather); and/or the like. In some examples, the mode transition condition may be dependent on an engine warming requirement. An engine warming requirement may comprise a requirement to run the engine to produce heat, for example to heat up an exhaust after-treatment system.

Additionally, or alternatively, the mode transition condition for the mode change may be dependent on a manual selection of the vehicle operating mode; or a request from a vehicle subsystem dependent on activation of the engine 202, such as a climate control subsystem (e.g. cabin heater).

In some examples, the second vehicle operating mode may be the parallel HEV mode in which the engine 202 is in a connected state and activated, to provide tractive torque to the vehicle wheels, such as the first set of vehicle wheels FL, FR of FIG. 2. The torque path 220 is connected. The vehicle 10 of FIG. 2 would be configured for all-wheel drive.

In some examples, the second vehicle operating mode may be the internal combustion engine mode in which the engine 202 is in the connected state and activated, and the second electric machine 212 is in a deactivated state not configured to provide tractive torque. The vehicle 10 of FIG. 2 would be two-wheel driven, or more specifically front-wheel driven. In some examples, the engine 202 may charge the traction battery 200 as described above.

If the mode change is performed while the vehicle 10 is moving too slowly, then a jerk may be felt by the vehicle occupant. The jerk occurs it the vehicle speed (at the wheels) is lower than the vehicle speed required for engine speed to be at or above an engine idle speed target. The engine idle speed target is generally controllable but no less than a predetermined minimum speed associated with stall or excessive engine vibration.

Low-speed jerk is caused by the torque path connector 218 connecting an input shaft on the engine side, to an output shaft at the wheel side. The input shaft speed is much higher than the synchronization speed required to connect the input shaft to the output shaft. The connection would cause the input shaft speed (and torque converter speed) to reduce, as the energy inherent in the inertia of the spinning shafts is transferred to the output shaft. This causes perceptible jerk. Jerk can also occur if the output shaft is spinning faster than the input shaft. It is difficult to avoid jerk when performing a connection of the front axle during rear-axle electric vehicle creep. The balance between rear axle and front axle creep control is difficult because the rear axle torque must be reduced at the same rate as the connection introduces front axle torque, in order for no change to be perceptible. Reducing the rate of connection may cause excessive slippage of the torque path connector 218, so is not an ideal solution. Further, the rear axle torque may not be able to reduce quickly without causing a shunt during a zero-crossing point of torque (lash crossing).

The best time to perform the mode change is when the vehicle speed is a speed required for the engine speed to approximately match the desired engine speed, such as the engine idle speed target.

If the electric vehicle creep function accurately replicates engine behaviour, then during vehicle creep the vehicle speed may be well-matched to the engine idle speed target and the jerk may be relatively low or almost eliminated in a mode change during vehicle creep. However, such an electric vehicle creep function would be difficult to calibrate, and must be constrained by design to accurately match expected engine behaviour. In some examples, it may be desirable to provide more flexibility over how the electric vehicle creep function is implemented. For example, the electric vehicle creep function may be configured to behave less like an engine 202 such that: the vehicle creep speed target is the same in drive and reverse gears; and/or the vehicle creep speed is the same regardless of whether the vehicle 10 is entering creep from stationary or decelerating from a higher speed. However, a more noticeable jerk may occur during the mode change.

When the mode change is required at block 402, the outputting of a signal to connect the engine 202 to the vehicle wheels may be delayed until a trigger condition is satisfied. The trigger condition comprises one or more criteria. In FIG. 4, but not necessarily all examples, the mode change is delayed unless any one of the trigger conditions of blocks 404, 406 and 408 is satisfied. In other implementations, just one of the decision blocks 404, 406 or 408, or any other combination thereof, is performed.

In decision block 404, the method 400 comprises determining whether a torque request is greater than a torque threshold. If the torque request is greater than the torque threshold, then block 404 triggers the mode change.

The torque threshold may correspond to an upper (e.g. maximum) torque capability of the second electric machine 212. The threshold may be constant or a variable. A variable torque threshold is useful because the maximum torque capability could be affected by issues such as overheating.

Performing the mode change when the torque request is greater than the torque threshold enables the vehicle 10 to produce more net torque at the vehicle wheels. This is because the second electric machine 212 and the engine 202 together can provide more tractive torque than the second electric machine 212 alone.

Block 404 may comprise receiving the torque request. The torque request may be a vehicle torque request. The vehicle torque request may based on a driver torque demand, autonomous driving torque demand, or adaptive cruise control torque demand, for example. The value of the torque threshold depends on implementation.

If the torque request is less than the torque threshold, then block 404 does not trigger the mode change and the method 400 may proceed towards block 408.

In the next decision block 405, the method 400 comprises determining whether a vehicle braking requirement holding the vehicle 10 stationary is below a brake threshold and a vehicle speed is below a stationary vehicle threshold. The stationary vehicle threshold may require the vehicle speed to be equal to zero, or less than a small value, e.g. up to 1 metre per second. The vehicle speed may comprise vehicle speed as measured before or after a gear reduction. The vehicle braking requirement may be a brake load, for example. If the vehicle braking requirement is below the brake threshold, then there is a chance that the mode change could cause the vehicle 10 to move forward.

Therefore, when the vehicle braking requirement is below the threshold, block 406 does not trigger the mode change, and the method 400 may proceed towards block 408. However, if the brake load is greater than the brake threshold, then the vehicle 10 is secure and the connection of the engine 202 will not cause the vehicle 10 to move forward. Therefore. block 406 triggers the mode change.

Block 406 may comprise receiving the vehicle braking requirement. The vehicle braking requirement may be dependent on brake pedal depression. In some vehicles, brakes may be applied automatically. Vehicle braking may be applied through friction brakes and/or through a regenerative braking capability of an electric machine.

The next decision block 408 requires a vehicle speed to be above a rising speed threshold, before the mode change is allowed to be performed. The rising speed threshold may relate to a vehicle speed as measured before or after a gear reduction. The rising speed threshold is a threshold vehicle speed. The rising speed threshold is a vehicle speed that relates to approximately zero slip during the mode change. The term ‘approximately zero’ would be regarded as including a tolerance value.

If the vehicle 10 is moving but at a speed below the rising speed threshold, the mode change is inhibited until the vehicle speed has risen above the rising speed threshold. Inhibiting relates to delaying the mode change. The method 400 may loop back as shown and repeatedly check block 408.

In some examples, if the speed is below the rising speed threshold, block 409 is performed. Block 409 enables a mode change to series HEV mode if electrical energy needs to be generated, if required in order to enable the second electric machine 212 to continue driving the vehicle 10 without the engine 202 being connected to the vehicle wheels. However, the switch to the engine-connected second mode (parallel HEV mode or internal combustion engine mode) remains inhibited.

If the vehicle speed is above the rising speed threshold, the method 400 proceeds to block 410 which performs the mode change into the second operating mode. In the example of FIG. 2, block 410 comprises connecting the torque path 220. The engine 202 is therefore connected to the vehicle wheels. The vehicle 10 is therefore in the parallel HEV mode or the internal combustion engine mode.

In some, but not necessarily all examples, the rising speed threshold may be a value of at least approximately one metre per second. If the threshold is too low, the engine 202 may stall or vibrate excessively when connected to the vehicle wheels. The precise value of the rising speed threshold depends on a stall speed and maximum gear reduction available in the vehicle 10, and torque converter characteristics. For a non-industrial passenger vehicle with a typical gear reduction, the rising speed threshold may be a value of at least approximately 1.5 metres per second. 1.5 metres per second is just under six kilometres per hour.

In some, but not necessarily all examples, the rising speed threshold corresponds to a vehicle speed at the vehicle wheels of up to approximately four metres per second. Four metres per second is just over 13 kilometres per hour. In some examples the rising speed threshold is less than four metres per second e.g. up to three metres per second, up to two metres per second, up to 1.5 metres per second or up to one metre per second. If the rising speed threshold is too high, then the vehicle 10 will be unable to change modes for too long, which would be undesirable because the mode change is required by the mode transition condition, with minimal delay.

The rising speed threshold may be a constant or a variable. The rising speed threshold may be greater than or equal to a speed setpoint associated with vehicle creep. The rising speed threshold may be dependent on the earlier-defined vehicle creep speed setpoint. The rising speed threshold may be equal to or a predetermined amount greater than the vehicle creep speed setpoint. The vehicle creep speed setpoint may be constant or a variable. The vehicle creep speed setpoint may be a vehicle speed required for engine speed to be at or above an engine speed target such as the engine idle speed target. The engine speed target may be fixed or variable. Usually the engine idle speed target is variable.

In some, but not necessarily all examples the rising speed threshold depends on a selected gear ratio of the transmission 204. The selected gear ratio may be dependent on a selected gear in the transmission 204.

The gear ratio selection may be performed as a consequence of block 402. For example, the control system 208 or another control system may select a low gear (high gear reduction) such as first gear as standard, however in some situations a higher gear (lower gear reduction) may be selected to obviate the need for another gear change when the torque path 220 is connected. If a higher gear is selected, then a higher vehicle speed is required in order for the engine speed to match its engine speed target. The control system 208 determines the selected gear ratio, and controls the rising speed threshold in dependence thereof.

In some, but not necessarily all examples, the dependency on gear ratio selection arises because the vehicle creep speed setpoint and/or engine idle speed setpoint depends on the selected gear ratio.

If the first operating mode is the electric vehicle mode and electrical energy availability is low, the control system 208 may switch to a different first operating mode such as the series HEV operating mode to ensure that electrical power is constantly available prior to the mode change. This enables continuous electric vehicle creep. The engine idle speed target may be increased relative to the second operating mode so that the engine, via the first electric machine, provides greater electrical power for faster charging.

Once one of the trigger conditions has been satisfied, the method 400 proceeds to block 410 to perform the mode change. Performing the mode change comprises outputting a signal causing performance of the mode change to the second operating mode. In summary, the above operations of the method 400 inhibit (delay) the mode change until a rising speed threshold is exceeded, or unless vehicle brakes holding the vehicle stationary are firmly applied. However, if a high torque request is received, the inhibition is removed to cause an immediate mode change.

FIG. 4 additionally includes the second subroutine 412, 414 relating to a second mode change from the second operating mode to a first operating mode. The required first operating mode could be the same first vehicle operating mode as block 402, or could be a different first vehicle operating mode in which the engine 202 is in a disconnected state not configured to provide tractive torque, and an electric machine is configured to provide tractive torque.

The blocks 412 and 414 relate to a falling speed threshold. The falling speed threshold is another example of a threshold vehicle speed.

Decision block 412 comprises determining whether the vehicle speed falls below the falling speed threshold. If the vehicle speed is below the falling speed threshold, the method 400 proceeds to block 414 which outputs a signal causing performance of the mode change to the first operating mode, assuming the vehicle 10 is not already in the first operating mode.

If the vehicle speed is greater than the falling speed threshold, then block 412 does not trigger the mode change to the first operating mode, and the method 400 may loop back to repeatedly check block 412.

The falling speed threshold may be identical to the rising speed threshold e.g. 4 metres per second, or different within the earlier-defined range of the rising speed threshold. The falling speed threshold may be a constant, or a variable for the same reasons as the rising speed threshold.

If blocks 408 (rising speed threshold) and 412 (falling speed threshold) are both implemented, then a range of low vehicle speeds is defined within which the control system 208 will operate the vehicle 10 in the first operating mode, by default. The vehicle 10 will be kept in the first operating mode whenever the vehicle speed is below the rising and falling speed thresholds. if the range of speeds is equal to or greater than vehicle creep speed, this has the effect that the vehicle 10 may always be in electric vehicle creep, by default. Electric vehicle creep would have a higher/default priority compared to natural, engine driven creep. The value of the falling speed threshold, e.g. no greater than 4 metres per second, is a value approximately equal to a typical electric vehicle creep speed but may be higher or lower than that. The value may never be so high or so low as to affect low-speed driving or coasting. In some examples, the falling speed threshold is less than four metres per second e.g. up to three metres per second, up to two metres per second, up to 1.5 metres per second or up to one metre per second, but never zero, to ensure that the mode transition occurs when the vehicle speed is close to the vehicle creep speed.

Block 412 acts as both a mode transition condition and a trigger condition for changing to the first operating mode, whereas in earlier blocks 402 and 408 (rising speed) the transition and trigger conditions were separate. In other examples, falling vehicle speed could be one of several requirements (not shown) that must be satisfied to trigger block 414.

For purposes of this disclosure, it is to be understood that the controller(s) described herein can each comprise a control unit or computational device having one or more electronic processors. A vehicle and/or a system thereof may comprise a single control unit or electronic controller or alternatively different functions of the controller(s) may be embodied in, or hosted in, different control units or controllers. A set of instructions could be provided which, when executed, cause said controller(s) or control unit(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, optionally the same one or more processors as the first controller it will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

It will be appreciated that various changes and modifications can be made to the present invention without departing from the scope of the present application.

The blocks illustrated in FIG. 4 may represent steps in a method and/or sections of code in the computer program 306. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant reserves the right to claim protection in respect of any patentable feature or combination of features hereinbefore referred to and/or shown in the drawings whether or not particular emphasis has been placed thereon.

In the claims:

1. A control system for controlling connection of an internal combustion engine of a vehicle having an internal combustion engine and a first electric machine, the vehicle operable in an electric mode of operation, a series hybrid mode of operation, and a parallel hybrid mode of operation, the control system comprising one or more controllers, wherein the control system is configured to:
automatically select a vehicle operating mode of the vehicle;
determine a mode transition condition for exiting the electric mode of operation in response to a traction battery state of charge falling below a threshold;
determine that a trigger condition is satisfied, wherein satisfaction of the trigger condition is dependent on a vehicle speed of the vehicle relative to at least threshold speed comprising a rising speed threshold, the rising speed threshold speed having a value corresponding to a vehicle speed no greater than four metres per second; and
based at least on the determination, control when a mode change between a first operating mode and a second operating mode is performed,
wherein in the first operating mode is a series hybrid vehicle operating mode in which the internal combustion engine is configured to provide torque to a second electric machine to generate electrical energy , and the first electric machine is configured to provide tractive torque, and
wherein in the second operating mode at least the internal combustion engine is in a connected state configured to provide tractive torque.

2. The control system of claim 1, wherein when the vehicle speed is at or above the rising speed threshold, the mode change is performed from the first operating mode to the second operating mode.

3. The control system of claim 2, configured to:
determine that the mode change is required; and
if the vehicle is moving but at the vehicle speed is below the rising speed threshold, inhibit the mode change until the vehicle speed has risen above the rising speed threshold.

4. The control system of claim 3, wherein the inhibition is overridden if a torque request is greater than a torque threshold, enabling connection of the internal combustion engine before the vehicle speed reaches the rising speed threshold.

5. The control system of claim 3, wherein satisfaction of the trigger condition is dependent on a vehicle braking requirement, and wherein the at least one threshold comprises a stationary vehicle threshold, wherein the control system is configured to:
if the vehicle braking requirement is below a brake threshold and the vehicle speed is below the stationary vehicle threshold, inhibit the mode change until the vehicle speed has risen above the rising speed threshold or until the vehicle braking requirement has risen above the brake threshold.

6. The control system of claim 3, wherein the determination that the mode change is required is dependent on one or more of: electrical energy availability; a manually-selected vehicle operating mode; or a request from a vehicle subsystem dependent on activation of the internal combustion engine.

7. The control system of claim 3, wherein the rising speed threshold is greater than or equal to a speed setpoint associated with vehicle creep,
wherein the speed setpoint comprises a vehicle creep speed setpoint, and wherein in the first operating mode the electric machine is configured to provide tractive torque to satisfy the vehicle creep speed setpoint.

8. The control system of claim 1, wherein the at least one threshold comprises a falling speed threshold, wherein when the vehicle speed has fallen below the falling speed threshold, the mode change is performed from the second operating mode to the first operating mode.

9. The control system of claim 1, wherein the at least one threshold depends on a selected gear ratio.

10. (canceled)

11. The control system of claim 1, wherein in the first operating mode engine idle speed is increased.

12. A system comprising the control system of claim 1, the electric machine, and the internal combustion engine.

13. A vehicle comprising the system of claim 12, wherein
the vehicle is configured to mechanically provide torque from the internal combustion engine to a first axle of the vehicle and from the electric machine to a second axle of the vehicle, but is not capable of mechanically providing torque from the internal combustion engine to the second axle and is not capable of mechanically providing torque from the electric machine to the first axle.

14. A method of controlling connection of an internal combustion engine of a vehicle having an internal combustion engine and a first electric machine, the vehicle operable in an electric mode of operation, a series hybrid mode of operation, and a parallel hybrid mode of operation, the method comprising:
automatically selecting a vehicle operating mode of the vehicle;
determining a mode transition condition for exiting the electric mode of operation in response to a traction battery state of charge falling below a threshold;
determining that a trigger condition is satisfied, wherein satisfaction of the trigger condition is dependent on a vehicle speed of the vehicle relative to at least one threshold speed comprising a rising speed threshold, the rising speed threshold speed having a value corresponding to a vehicle speed no greater than four metres per second; and
based at least on the determination, controlling when a mode change between a first operating mode and a second operating mode is performed,
wherein the first operating mode is a series hybrid vehicle operating mode in which the internal combustion engine provides torque to a second electric machine to generate electrical energy, and an the first electric machine is configured to provide tractive torque, and
wherein in the second operating mode at least the internal combustion engine is in a connected state configured to provide tractive torque.

15. A computer product having a non-transitory, computer-readable memory storing computer software that, when executed, is arranged to perform a method according to claim 14.

16. The control system of claim 1, wherein the one or more controllers collectively comprise: at least one electronic processor having an electrical input for receiving information; and at least one electronic memory device electrically coupled to the at least one electronic processor and having instructions stored therein; and wherein the at least one electronic processor is configured to access the at least one memory device and execute the instructions thereon so as to cause the control system to perform the determining and the mode change.
